(19) United States
(12) Patent Application Publication
(10) Pub. No.: US 2023/0272163 A1
(43) Pub. Date: Aug. 31, 2023

(54) POLYAMIDE FOR TEXTILE APPLICATION

(71) Applicant: ARKEMA FRANCE, Colombes (FR)

(72) Inventors: Stefania CASSIANO GASPAR, SERQUIGNY (FR); Thierry BRIFFAUD, SERQUIGNY (FR); Jean-Jacques FLAT, SERQUIGNY (FR); Patrick DANG, SERQUIGNY (FR)

(73) Assignee: ARKEMA FRANCE, Colombes (FR)

(21) Appl. No.: 18/006,979

(22) PCT Filed: Jul. 27, 2021
(86) PCT No.: PCT/FR2021/051397

§ 371 Date: Jan. 26, 2023

(30) Foreign Application Priority Data
Jul. 29, 2020 (FR) FR2008016

(51) Int. Cl. C08G 69/26

(52) U.S. Cl. CPC C08G 69/26

(57) ABSTRACT

A linear aliphatic polyamide obtained by polycondensation of at least one linear aliphatic unit chosen from a C6 to C12 alpha, omega-aminocarboxylic acid, a C6 to C12 lactam and a (Ca-diamine).(Cb-diacid) unit, with a representing the number of carbon atoms of the diamine and b representing the number of carbon of the diacid, a and b being between 4 and 18, the polyamide having a difference, expressed as an absolute value, between its total acidity and its total basicity of between 35 and 180, and a total basicity or a total acidity strictly less than 35 μeq/g. Also, a method for its preparation and to its uses in the textile field.

### FIELD OF THE INVENTION

The present invention relates to a polyamide with improved textile properties. The invention also relates to its preparation method and to its use in making a textile material.

### STATE-OF-THE-ART

The use of synthetic textile fibers based on polyamide has been known for many years. Textiles include fiber mats (dressings, filters, felt), rovings (dressings), yarns (sewing threads, knitting threads, weaving threads), knitted fabrics (flat, circular, fully-fashioned or shaped), fabrics (traditional fabric, Jacquard fabric, multi-faceted fabric, double-sided fabric, multi-axial fabric, 2.5D fabric, 3D fabric), and many more. Innovations in this field are regularly appearing, for example in sportswear, which allows for easier elimination of sweat. Innovations in the ability of fibers to be dyed have also recently emerged. Thus, when textile materials are treated to impart a particular color, shape or a specific treatment, such as an antibacterial or flame-retardant treatment, the textile material may be subjected to several treatment steps and/or tougher treatments, making the fibers more fragile.

In addition, in view of current climate issues, textile materials that can be completely recycled are sought.

Thus, new materials are being sought that are stronger, both thermally and mechanically, and that have the advantage of being recyclable.

### DESCRIPTION OF THE INVENTION

The invention relates to a linear aliphatic polyamide obtained by polycondensation of at least one linear aliphatic unit chosen from a C6 to C12 alpha, omega-aminocarboxylic acid, a C6 to C12 lactam and a (Ca-diamine).(Cb-diacid) unit, with a representing the number of carbon atoms of the diamine and b representing the number of carbon of the diacid, a and b being between 4 and 18, the polyamide having
a difference, expressed as an absolute value, between its total acidity and its total basicity of between 35 and 180, and
a total basicity or a total acidity strictly lower than 35 μeq/g.

The invention also relates to the method for preparing this polyamide.

The invention also relates to a composition comprising said polyamide.

Finally, the invention relates to a textile material made from the polyamide or from the composition containing it.

It was observed that the polyamide according to the invention exhibited excellent thermal stability properties and excellent mechanical properties. It also has excellent rheological stability. This means that it changes very little when hot. In other words, when it is melted to make a filament, its viscosity changes very little. This property is highly sought after by manufacturers. Indeed, for example, if the production line has to be stopped for any reason, such as a breakdown in the production line, it can be restarted without losing the material in the production process. The molten material will have changed little or not at all during this interruption, and the filaments produced during this stop will have the required specificities. No loss will be recorded.

Furthermore, the polyamide according to the invention has the advantage that it can be recycled. Its rheological stability allows it to be easily remelted and reused to make new filaments. The property of remelted polyamide is very similar, if not identical, to those of a polyamide that is melted for the first time.

### DESCRIPTION OF EMBODIMENTS OF THE INVENTION

Other characteristics, features, subjects and benefits of the present invention will appear even more clearly after reading the description that follows.

The nomenclature used to define the polyamides is described in ISO standard 1874-1:2011 “Plastiques—Matériaux polyamides (PA) pour moulage et extrusion—Partie 1: Designation”, in particular on page 3 (Tables 1 and 2) and is well known to the person skilled in the art.

It is further indicated that the expressions “between . . . and . . . ” and “from . . . to . . . ” used in the present description must be understood as including each of the indicated limits.

The word “polyamide” covers both homopolyamides and copolyamides.

In the present description of the invention, the following is understood:
“textile material” or “textile” means any material made from fibers or filaments and any material forming a porous membrane characterized by a length-to-thickness ratio of at least 300;
“fiber” means any synthetic or natural material, characterized by a length/diameter ratio of at least 300;
“filament” means any fiber of infinite length.

The invention will now be described in more detail, in a non-limiting fashion, in the following description.

### Polyamide

The polyamide according to the invention is obtained by polycondensation of at least one linear aliphatic unit chosen from a C6 to C12 alpha, omega-aminocarboxylic acid, a C6 to C12 lactam and a (Ca-diamine).(Cb-diacid) unit, with a representing the number of carbon atoms of the diamine and b representing the number of carbon of the diacid, a and b being between 4 and 18.

The polyamide according to the invention may be obtained by polycondensation of at least one lactam chosen among pyrrolidinone, 2-piperidinone, enantholactam, caprylolactam, pelargolactam, decanolactam, undecanolactam, and lauryllactam.

The polyamide according to the invention can also be obtained by polycondensation of at least one amino acid chosen from 10-aminodecanoic acid (denoted 10), 11-aminoundecanoic acid (denoted 11), 12-aminododecanoic acid (denoted 12).

The polyamide may be obtained by polycondensation of at least one unit satisfying the formula (Ca diamine). (Cb diacid), with a representing the number of carbon atoms of the diamine and b representing the number of carbon of the diacid, a and b being between 4 and 18.

The unit (Ca diamine) may be chosen from butanediamine (a=4), pentanediamine (a=5), hexanediamine (a=6), heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), and octadecanediamine (a=18).

The unit (Cb diacid) may be chosen from succinic acid (b=4), pentanedioic acid (b=5), adipic acid (b=6), heptanedioic acid (b=7), octanedioic acid (b=8), azelaic acid (b=9), sebacic acid (b=10), undecanedioic acid (b=11), dodecanedioic acid (b=12), brassylic acid (b=13), tetradecanedioic acid (b=14), hexadecanedioic acid (b=16), and octadecanedioic acid (b=18).

According to a preferred embodiment, the polyamide according to the invention is a homopolyamide. This homopolyamide can be obtained by the polycondensation of a lactam, an amino acid or a unit (Ca diamine).(Cb diacid), with Ca and Cb being as defined hereinbefore.

Preferably, the polyamide according to the invention is a linear aliphatic homopolyamide obtained by polycondensation of one linear aliphatic unit chosen from a C6 to C12 alpha, omega-aminocarboxylic acid, a C6 to C12 lactam and a (Ca-diamine).(Cb-diacid) unit, with a representing the number of carbon atoms of the diamine and b representing the number of carbon of the diacid, a and b being between 4 and 18, the polyamide having
a difference, expressed as an absolute value, between its total acidity and its total basicity of between 35 and 180, and
a total basicity or a total acidity strictly less than 35 μeq/g.

Even more preferably, the polyamide according to the invention is a linear aliphatic homopolyamide obtained by polycondensation of one linear aliphatic unit chosen from a C8 to C12 alpha, omega-aminocarboxylic acid, a C8 to C12 lactam and a (Ca-diamine).(Cb-diacid) unit, with a representing the number of carbon atoms of the diamine and b representing the number of carbon of the diacid, a and b being between 8 and 12, the polyamide having
a difference, expressed as an absolute value, between its total acidity and its total basicity of between 35 and 180, and
a total basicity or a total acidity strictly less than 35 μeq/g.

Advantageously, the homopolyamide according to the invention is chosen from PA11, PA12, PA1010, PA 1012, more particularly the PA11. The PA11 is obtained by polycondensation of the 11-aminoundecanoic acid. The PA12 is obtained by polycondensation of the lauryllactam. The PA1010 is obtained by polycondensation of the decanediamine and the decanedioic acid. The PA1012 is obtained by polycondensation of the decanediamine and the dodecanedioic acid.

The PA11 has the advantage of being made from raw materials of plant origin. Plant materials can be grown in large quantities, depending on demand, over most of the globe and be biobased. A biobased raw material is a natural resource, whether animal or plant, whose stock can be reconstituted over a short period of time on a human scale. In particular, this stock must be able to be renewed as quickly as it is consumed.

The basic raw material of the PA11 is castor oil, which is extracted from the castor oil plant (common ricin), specifically from castor seeds. PA11 is obtained by polycondensation of 11-aminoundecanoic acid.

According to another embodiment, the polyamide is a linear aliphatic copolyamide obtained by polycondensation of at least two monomers of different structures, of formula A/B
wherein
the unit A is chosen from a C6 to C12 alpha, omega-aminocarboxylic acid, a C6 to C12 lactam and a (Ca-diamine).(Cb-diacid) unit, with a representing the number of carbon atoms of the diamine and b representing the number of carbon of the diacid, a and b being between 4 and 18,
the unit B is chosen from a C6 to C12 alpha, omega-aminocarboxylic acid, a C6 to C12 lactam and a (Ca-diamine).(Cb-diacid) unit, with a representing the number of carbon atoms of the diamine and b representing the number of carbon of the diacid, a and b being between 4 and 18,
A and B being of different structures, the polyamide having
a difference, expressed as an absolute value, between its total acidity and its total basicity of between 35 and 180, and
a total basicity or a total acidity being strictly less than 35 μeq/g.

Preferably, the unit A is selected from a C8 to C12 alpha, omega-aminocarboxylic acid, a C8 to C12 lactam and a (Ca-diamine).(Cb-diacid) unit, with a representing the number of carbon atoms of the diamine and b representing the number of carbon of the diacid, a and b being between 8 and 12, the unit B is selected from a C8 to C12 alpha, omega-aminocarboxylic acid, a C8 to C12 lactam and a (Ca-diamine).(Cb-diacid) unit, with a representing the number of carbon atoms of the diamine and b representing the number of carbon of the diacid, a and b being between 8 and 12.

Preferably, the polyamide is selected from PA11/1010, PA11/1012, PA11/1212, PA1010/1012, PA1010/1212, PA12/1010, PA 12/1012, PA12/1212.

### Total Acidity and Total Basicity

The polyamide according to the invention has a difference, expressed as an absolute value, between its total acidity and its total basicity of between 35 and 180.

For the purposes of the present invention, difference, expressed as an absolute value, means the result of subtracting the values of total acidity and total basicity, without taking into account the sign.

Preferably, the difference, expressed as an absolute value, between the total acidity and the total basicity is between 40 and 110.

The polyamide according to the invention also has a total basicity or a total acidity strictly less than 35 μeq/g.

Acidity and basicity are measured by potentiometry.

Acidity is measured in accordance with the following method. A sample of polyamide is dissolved in benzyl alcohol. Next, this sample is dosed by potentiometry with a 0.02 N tetrabutylammonium hydroxide solution.

Basicity is measured in accordance with the following method. A sample of polyamide is dissolved in metacresol. Next, this sample is potentiometrically titrated with a 0.02 N perchloric acid solution.

According to one embodiment of the invention, the polyamide has a total basicity strictly less than 35 μeq/g and a total acidity between 70 and 180 μeq/g.

Preferably, the polyamide has a total acidity between 75 and 130 μeq/g. Preferably, the polyamide has a total basicity less than or equal to 30 μeq/g, and more particularly between 5 and 30 μeq/g.

According to one embodiment of the invention, the polyamide has a total acidity is strictly less than 35 μeq/g and a total basicity between 60 and 180 μeq/g, preferably between 60 and 130 μeq/g.

Preferably, the polyamide has a total basicity between 60 and 130 μeq/g. Preferably, the polyamide has a total acidity less than or equal to 30 μeq/g, and more particularly between 5 and 25 μeq/g.

According to a preferred embodiment, the homopolyamide according to the invention is the PA11 or the PA12, having a total acidity between 75 and 130 μeq/g and a total basicity between 5 and 30 μeq/g.

Inherent Viscosity

Preferably, the polyamide according to the invention has an inherent viscosity of between 0.70 and 1.70, advantageously between 0.70 and 1.50, preferably between 0.80 and 1.20, even more particularly between 0.85 and 1.15.

The inherent viscosity is measured at a polyamide concentration of 0.5 wt. % solution in metacresol relative to the total weight of the solution, at 20° C., by means of a viscometer equipped with a Micro-Ubbelohde viscometer tube.

### Crystallinity

Preferably, the polyamide has a crystallinity of between 20 and 40%, especially between 20 and 30%, measured by DSC (differential scanning calorimetry) according to standard 11357-3, 1999 (2^{nd} DSC heating at 20° C./min according to standard ISO 11357).

Crystallinity is calculated according to the following formula:

$$x = \frac{Δ {Hf}^{⋆}}{Δ Hf} \times 100$$

wherein
χ is the crystallinity,
ΔH_{f}* is the enthalpy of fusion of the polyamide
ΔH_{f} is the enthalpy of fusion of 100% crystalline polyamide. This value may be a theoretical value obtained by mathematical models, or if the sample is available, it may be the value measured on that sample.

### Chain Stoppers

Advantageously, the polyamide according to the invention is limited by a linear aliphatic C2-C18 monocarboxylic acid, a linear aliphatic C4-C18 monoamine, a linear aliphatic C3-C36 dicarboxylic acid and/or a linear aliphatic C4-C18 diamine.

The acid used as a chain stopper may be selected from acetic acid, propionic acid, lactic acid, valeric acid, caproic acid, capric acid, lauric acid, tridecylic acid, myristic acid, palmitic acid, stearic acid, pivalic acid, isobutyric acid, succinic acid, pentanedioic acid, adipic acid, heptanedioic acid, octanedioic acid, azelaic acid, sebacic acid, undecanedioic acid, dodecanedioic acid, brassylic acid, tetradecanedioic acid, hexadecanedioic acid, octadecanedioic acid, octadecenedioic acid, eicosanedioic acid, and docosanedioic acid.

Preferably, the polyamide according to the invention is limited by a linear aliphatic C6-C12 monocarboxylic acid and/or a linear aliphatic C6-C12 dicarboxylic acid, and particularly preferably by a linear aliphatic C6-C12 dicarboxylic acid. The preferred acids are adipic acid, sebacic acid and lauric acid.

The amine used as a chain stopper may be selected from butylamine, hexylamine, octylamine, decylamine, laurylamine, stearylamine, diethylamine, dipropylamine, dibutylamine, hexanediamine, heptanediamine, octanediamine, nonanediamine, decanediamine, undecanediamine, dodecanediamine.

Preferably, the polyamide according to the invention is limited by a C6-C12 monoamine and/or a C6-C12 diamine. Preferably, decanediamine and laurylamine are used.

According to a particularly preferred embodiment of the invention, the polyamide is obtained by polycondensation of at least one linear aliphatic unit chosen from a C6 to C12 alpha, omega-aminocarboxylic acid, a C6 to C12 lactam and a (Ca-diamine).(Cb-diacid) unit, with a representing the number of carbon atoms of the diamine and b representing the number of carbon of the diacid, a and b being between 4 and 18, the polyamide having
a difference, expressed as an absolute value, between its total acidity and its total basicity of between 35 and 180,
a total basicity strictly less than 35 μeq/g, and
a total acidity between 70 and 180 μeq/g,
the polyamide being limited by a monoacid or a diacid.

Preferably, the polyamide is a homopolyamide obtained by polycondensation of a linear aliphatic unit selected from a C6 to C12 alpha, omega-aminocarboxylic acid and a C6 to C12 lactam, the polyamide having
a difference, expressed as an absolute value, between its total acidity and its total basicity of between 35 and 180,
a total basicity strictly less than 35 μeq/g, and
a total acidity between 70 and 180 μeq/g,
the polyamide being limited by a monoacid or a diacid.

### Method of Preparation

The method for preparing the polyamide according to the invention comprises a step of mixing the monomers in the melt stage, and at least one chain terminator, water and optionally other additives. This step is generally carried out at a temperature of between 100 and 300° C., and under a pressure of between 3 and 35 bar. This step can be performed in batch or continuous mode.

The water vapor is then removed by degassing and the pressure is lowered, until atmospheric pressure is reached.

Finally, the polycondensation is continued under nitrogen or vacuum until the desired molecular weight is obtained.

The method may also comprise a subsequent filtration step to ensure that the polyamide is low in impurities. For example, the filtration step may be performed in an additional compounding step.

The addition of additives can be carried out during the polymerization of the monomers or in an additional compounding step.

### Composition

The invention also relates to a composition comprising the polyamide as defined hereinbefore.

The composition may comprise at least one additive selected from flame retardants, UV protectants, UV stabilizers, optical brighteners, thermal stabilizers, pigments, lubricants, antioxidants, flow improvers, flowability improvers, film-forming agents, fillers, filming aids, gums, semi-crystalline polymers, preservatives, anti-bacterial agents and mixtures thereof.

Preferably, the composition comprises predominantly, that is at least 50% by weight relative to the total weight of the polyamide composition, and preferably between 70 and 90%.

According to one preferred embodiment, the composition according to the invention comprises the polyamide according to the invention and at most 10% by weight with respect to the total weight of the composition of at least one additive.

According to a preferred embodiment, the composition according to the invention comprises, as the polyamide, PA11 or PA12, the polyamide having
a difference, expressed as an absolute value, between its total acidity and its total basicity of between 35 and 180,
a total basicity strictly less than 35 μeq/g, and
a total acidity between 70 and 180 μeq/g,
the polyamide being limited by a linear aliphatic C6-C12 dicarboxylic acid, and preferably by the adipic acid,
and at most 10% by weight with respect to the total weight of the composition of at least one additive.

According to a preferred embodiment, the composition according to the invention comprises, as the polyamide, PA11 or PA12, the polyamide having
a difference, expressed as an absolute value, between its total acidity and its total basicity of between 35 and 180,
a total acidity strictly less than 35 μeq/g, and
a total basicity between 60 and 180 μeq/g,
the polyamide being limited by a linear aliphatic C6-C12 amine, and preferably by the decanediamine and laurylamine,
and at most 10% by weight with respect to the total weight of the composition of at least one additive.

### Uses

The polyamide according to the invention can be used for the manufacture of textile material, such as yarns, fibers, filaments, films, membranes, porous membranes, woven or non-woven textiles. The present invention also relates to the manufacture and use of molten polyamide particles to make them adhere to the surface of textile materials in a durable manner (wash resistance).

The composition as defined hereinbefore can also be used for the manufacture of textile material, such as yarns, fibers, filaments, films, membranes, porous membranes, woven or non-woven textiles.

The polyamide or polyamide-based compositions can be shaped into textile material directly after polymerization, without intermediate solidification and remelting steps. The polyamide or these compositions may also be shaped as granules to be and remelted for subsequent final shaping, for example for the manufacture of molded textile articles or for the manufacture of yarns, fibers and/or filaments.

All melt spinning processes can be used in particular by passing the polyamide or the composition of the invention through spinnerets comprising one or more orifices. For the manufacture of multifilament yarns, the spinning or spin-drawing or spin-draw-texturing processes are possible, either integrated or not, regardless of the spinning speed. The yarns can be produced by high-speed spinning, at a spinning speed greater than or equal to 3000 m/min, preferably greater than or equal to 4000 m/min. Such processes are often referred to by the following terms: POY (partially oriented yarn), FOY (fully oriented yarn), ISD (integrated spin-drawing), HOY (highly oriented yarn with a speed greater than 5500 m/min). These yarns can also be textured, depending on their intended use. The yarns obtained by these processes are particularly suitable for the production of textile, woven or knitted surfaces. According to the invention, the thermoplastic polymer matrix made of polyamide according to the invention can be used for the manufacture of monofilament yarns or monofilaments, multifilament yarns or multifilaments, continuous (spool) and/or discontinuous (staple) fibers. Homopolyamide discontinuous fibers are particularly suitable for blending with natural fibers.

For single fibers or monofilaments, the titer can range from 1.5 dtex to 100 dtex/filament, with higher titers being particularly suitable for industrial applications. Multifilament yarns preferably have a titer of less than or equal to 6 dtex/filament. For the production of fibers, the filaments can, for example, be combined in the form of a strand or lap, directly after spinning or in a re-spinning process, drawn, textured or crimped and cut. The resulting fibers can be used for the production of non-wovens or fiber yarns. The polyamide or compositions can also be used for the manufacture of flocs. The yarns, fibers and/or filaments of the invention may undergo various treatments such as, for example, drawing in a continuous or re-drawing step, sizing, oiling, interlacing, texturing, crimping, drawing, fixing or relaxing heat treatment, milling, twisting and/or dyeing. For dyeing, particular mention is made of the bath or jet dyeing processes. The preferred dyes are acid, metal and non-metal dyes.

In one embodiment, the tenacity of a filament of a polyamide of the invention is greater than 3.5 cN/dTex, in particular greater than 4 cN/dTex, in particular it is from 4 to 10 cN/dTex.

The invention also relates to a filament consisting of polyamide as defined hereinbefore or consisting of the composition as defined hereinbefore.

### Textile

The invention also relates to a textile made from polyamide or the composition defined hereinbefore.

The present invention also relates to a textile (or textile article or textile material) obtained at least partially from the polyamide previously defined, in the form of yarns, fibers and/or filaments as previously defined. These textile materials or articles may be fabrics or textile surfaces, such as woven, knitted, non-woven or carpeting surfaces. Such articles may be, for example, carpets, rugs, upholstery, surface coverings such as sofa coverings, curtains, bedding, mattresses and pillows, clothing and medical textile materials.

The textile according to the invention advantageously constitutes a felt, a filter, a film, a gauze, a cloth, a dressing, a layer, a fabric, a knitted fabric, an article of clothing, a garment, an article of bedding, an article of furnishing, a curtain, an interior lining, a functional technical textile, a geotextile and/or an agrotextile.

Said textile is advantageously used in the field of medicine, hygiene, luggage, clothing, household or home equipment, furnishings, carpets, automotive, industry, especially industrial filtration, agriculture and/or construction.

The present invention also relates to textile articles obtained by shaping a polyamide matrix or a thermoplastic composition comprising the polyamide according to the invention by an extrusion process, in particular by melt extrusion, in particular the extrusion of sheets, films and filaments. Films can thus be obtained by the above-mentioned processes using a flat die. The films obtained may undergo one or more treatment steps, such as one-dimensional or two-dimensional stretching, thermal stabilization treatment, antistatic treatment and/or sizing.

When the textiles according to the invention are manufactured predominantly on the basis of a PA11 according to the invention (comprising at least 50% by weight of PA11), then these textiles exhibit further advantageous properties. They are light, flexible, soft to the touch, resistant to tearing, cutting, abrasion, and pilling, and are cool at first touch.

Advantageously, said textile further comprises natural fibers such as cotton, wool and/or silk, artificial fibers made from natural raw materials, metal fibers and/or synthetic fibers other than polyamide fibers according to the invention.

Advantageously, said textile comprises synthetic fibers obtained from biobased raw materials. Preferably, the textile according to the invention is manufactured solely from biobased raw materials.

Renewable raw materials or biobased raw materials are materials that comprise biobased carbon or carbon from renewable sources. Indeed, unlike materials made from fossil fuels, materials made from renewable raw materials contain ¹⁴C. “Renewable carbon content” or “biobased carbon content” is determined in accordance with ASTM D6866 (ASTM D6866-06) and, where applicable, ASTM D7026 (ASTM D7026-04). The first standard describes a test to measure the 14C/12C ratio of a sample and compares it with the ¹⁴C/¹²C ratio of a reference sample of 100% biobased origin, to give a relative percentage of biobased C in the sample. The standard is based on the same concepts as ¹⁴C dating, but without the application of dating equations. The ratio thus calculated is referred to as the “pMC” (percent Modern Carbon). If the material to be analyzed is a mixture of biomaterial and fossil material (without a radioactive isotope), then the pMC value obtained is directly correlated to the amount of biomaterial present in the sample. The ASTM D6866-06 standard proposes several techniques for measuring the ¹⁴C isotope content, based either on LSC (Liquid Scintillation Counting) or AMS/IRMS (Accelerated Mass Spectrometry coupled with Isotope Radio Mass Spectrometry). The preferred method of measurement used in the case of the present invention is mass spectrometry as described in ASTM D6866-06 (“accelerator mass spectroscopy”).

The textiles of the invention containing polyamide 11 according to the invention originate at least in part from biobased raw materials and thus have a biobased carbon content of at least 1%, which corresponds to an ¹²C/¹⁴C isotopic ratio of at least 1.2×10⁻¹⁴. Preferably, the textiles according to the invention comprise at least 50% by mass of biobased carbon relative to the total mass of carbon, which corresponds to a ¹²C/¹⁴C isotopic ratio of at least 0.6.10⁻¹². This content is advantageously higher, in particular up to 100%, which corresponds to a ¹²C/¹⁴C isotopic ratio of 1.2×10⁻¹². Textiles according to the invention can therefore comprise 100% biobased carbon or, alternatively, result from a mixture with a fossil origin.

According to a preferred embodiment, the textile according to the invention is made from PA11 or PA12, the polyamide having
a difference, expressed as an absolute value, between its total acidity and its total basicity of between 35 and 180,
a total basicity strictly less than 35 μeq/g, and
a total acidity between 70 and 180 μeq/g,
the polyamide being limited by a linear aliphatic C6-C12 dicarboxylic acid, and preferably by the adipic acid.

According to another preferred embodiment, the textile according to the invention is made from a composition comprising PA11 or PA12, the polyamide having
a difference, expressed as an absolute value, between its total acidity and its total basicity of between 35 and 180, and
a total acidity strictly less than 35 μeq/g, and
a total basicity between 60 and 180 μeq/g,
the polyamide being limited by an aliphatic linear amine and
at most 10% by weight with respect to the total weight of the composition of at least one additive.

Other purposes and advantages of the present invention will become apparent from the following examples, which are not intended to be limiting.

### EXAMPLES

### Example 1: Sample Preparation

The polyamide according to the invention denoted A is a PA11 limited by adipic acid (C6 diacid) in a proportion of 0.67% by weight with respect to the amount of 11-aminoundecanoic acid charged.

This polyamide is prepared according to the following process. The 11-aminoundecanoic acid, water and adipic acid are charged in a reactor and then placed in an inert atmosphere. The reaction medium was then heated to 235° C., while maintaining agitation. The reaction medium was kept at 235° C., under a pressure of 20 bar for 1.5 hours. Then, the pressure was lowered to 12 bar, while keeping the temperature at 235° C. The material was then transferred to a polymerizer, under nitrogen flushing at 235° C. The temperature was maintained under nitrogen flushing for 1.5 hours. The material was then extruded in the form of granules. This process was used for all of the example polyamides.

The polyamide according to the invention denoted B is a PA11 limited by lauric acid (C12 monoacid) in a proportion of 1.10% by weight with respect to the amount of 11-aminoundecanoic acid charged.

The polyamide according to the invention denoted C is a PA11 limited by laurylamine (C12 monoamine) in a proportion of 0.83% by weight with respect to the amount of 11-aminoundecanoic acid charged.

The polyamide according to the invention denoted D is a PA11 limited by decanediamine (C10 diamine) in a proportion of 0.80% by weight with respect to the amount of 11-aminoundecanoic acid charged.

The polyamide denoted E is a PA1010 limited by the excess of decanedioic acid added to a proportion of 0.90% by weight with respect to the sum of the weights of decanediamine and decanedioic acid at stoichiometry.

The comparative polyamide denoted F is a PA11 marketed by Arkema France under the trade designation Rilsan® BMNO.

The comparative polyamide denoted G is a PA11 marketed by Arkema France under the trade designation Rilsan® KNO.

The polyamide denoted H is a PA12 marketed by Arkema France under the trade designation Rilsamid®AECNO.

### Measurement of Inherent Viscosity

The inherent viscosity was measured at a polyamide concentration of 0.5 wt. % solution in metacresol relative to the total weight of the solution, at 20° C., by means of a viscometer equipped with a Micro-Ubbelohde viscometer tube.

### Measurement of Total Acidity

Acidity was measured in accordance with the following method. 1 g of polyamide was dissolved in 80 mL of benzyl alcohol under heat. The sample was then cooled. It was then potentiometrically titrated using a Metrohm titrator (888 or 716) with a combined pH electrode, by a 0.02 N tetrabutylammonium hydroxide solution. The potential versus volume curve gives a jump with an equivalent volume, from which the total acidity is calculated using the following formula:

$$Total acidity ( meq / g ) = \frac{Veq \times [ TBAOH ]}{m}$$

wherein
Veq is the equivalent volume obtained by the potentiometric titration,
[TBAOH] is the concentration of the tetrabutylammonium hydroxide solution, that is 0.02 N,
m is the mass of the sample, that is 1 g.

### Measurement of Total Basicity

Basicity was measured in accordance with the following method. 1 g of polyamide was dissolved in 80 mL of hot metacresol. The sample was then cooled. It was then potentiometrically titrated using a Metrohm titrator (888 or 716) with a combined pH electrode, by a 0.02 N perchloric acid solution in acetic acid. The potential versus volume curve gives a jump with an equivalent volume, from which the total basicity is calculated using the following formula:

$$Total basicity ( meq / g ) = \frac{Veq \times [ HClO 4 ]}{m}$$

wherein
Veq is the equivalent volume obtained by the potentiometric titration,
[HClO4] is the concentration of the perchloric acid solution, that is 0.02 N,
m is the mass of the sample, that is 1 g.

### Calculation of the Difference Between Total Acidity and Basicity

The difference is obtained by subtracting the total acidity and the total basicity from one another, in absolute value, that is without taking into account the sign.

For example, for PA 11 A:

Δ=|103−18|=85

The total basicity and acidity values for the polyamides tested are as follows:

| | Inherent | Total | Total | |
|---|---|---|---|---|
| | viscosity | acidity | basicity | |
| | (m-cresol) | (μeq/g) | (μeq/g) | Difference |
| PA11 A (inv) | 0.98 | 103 | 18 | 85 |
| PA 11 B (inv) | 0.92 | 81 | 27 | 54 |
| PA11 C (inv) | 1.09 | 24 | 64 | 40 |
| PA11 D (inv) | 1.06 | 16 | 97 | 71 |
| PA1010 E (inv) | 1.04 | 127 | 23 | 104 |
| PA 11 F (comp) | 0.97 | 150 | 60 | 90 |
| PA 11 G (comp) | 1.40 | 44 | 46 | 2 |
| PA 12 H (inv) | 1.09 | 100 | 20 | 80 |

### Example 2: Thermal Stability Analysis

The thermal stabilities of polyamides according to the invention and of a comparative polyamide when heated were analyzed.

The melt viscosity was evaluated under the following conditions:
Apparatus: PHYSICA MCR301
Geometry: parallel planes 25 mm in diameter
Temperatures: 220° C. and 240° C.
Frequency: 10 rad.s⁻¹
Deformation: 5%
Duration: 30 minutes
Atmosphere: Nitrogen flush.

These conditions are those of standard ISO 6721-10: 1999.

The results concerning the viscosity at 220° C. are reported in the following Table 2:

| | Viscosity | Viscosity | |
|---|---|---|---|
| | at t = 10 s | at t = 1800 s | % |
| | (Pa · s⁻¹) | (Pa · s⁻¹) | change |
| PA11 A (inv) | 137 | 161 | 17.5 |
| PA 11 B (inv) | 94 | 121 | 28.7 |
| PA 11 C (inv) | 198 | 239 | 21 |
| PA 11 D (inv) | 165 | 206 | 25 |
| PA 11 F (comp) | 354 | 1920 | 442 |
| PA 12 H (inv) | 251 | 313 | 24.7 |

The results concerning the viscosity at 240° C. are reported in the following Table 3:

| | Viscosity | Viscosity | |
|---|---|---|---|
| | at t = 10 s | at t = 1800 s | % |
| | (Pa · s⁻¹) | (Pa · s⁻¹) | change |
| PA11 A (inv) | 83 | 102 | 23 |
| PA 11 B (inv) | 58 | 82 | 41 |
| PA 11 C (inv) | 122 | 159 | 30 |
| PA 11 D (inv) | 103 | 152 | 48 |
| PA 11 G (comp) | 723 | 1208 | 67 |
| PA 12 H (inv) | 153 | 208 | 36 |

These results show that the polyamide according to the invention changes very little when heated. Its viscosity is practically constant over time; unlike comparative polyamides, which see their viscosity increase significantly over time at 220° C. and 240° C.

These results show that the polyamide according to the invention is perfectly recyclable.

### Example 3: Analysis of Thermal Resistance

The thermal resistances of a polyamide according to the invention and a comparative polyamide were analyzed.

Thermal resistance was assessed under the following conditions. The measurements were performed on the Netzsch TG 209F1 instrument, from 25 to 550° C. at 10° C./min under air and under nitrogen.

The results are shown in the following Table 4:

| | Start of degradation | Start of degradation |
|---|---|---|
| | under air in ° C. | under nitrogen in ° C. |
| PA11 A (inv) | 434 | 437 |
| PA11 C (inv) | 439 | 442 |
| PA11 D (inv) | 436 | 446 |
| PA 11 F (comp) | 403 | 402 |

These results show that the polyamide according to the invention has a better thermal resistance, both under air and under nitrogen.

These results indicate that the filament made from a polyamide according to the invention will have better mechanical properties, as it is much less sensitive to temperature.

### Example 4: Analysis of Elongation Properties

Dumbbell-shaped specimens were made according to standard ISO 527 1A from polyamide granules.

Tensile tests at 23° C. according to standard ISO 527 1A: 2012 were carried out. The test consists of applying a mechanical stress to the dumbbell-shaped specimen. The percentage of maximum elongation of the dumbbell-shaped specimen is measured before the second threshold.

The results are shown in the following Table 5:

| | Maximum % elongation |
|---|---|
| | before the 2^{nd} threshold |
| PA11 A (inv) | 270 |
| PA 11 B (inv) | 270 |
| PA 1010 E (inv) | 290 |
| PA11 F (comp) | 250 |
| PA 11 G (comp) | 240 |

These results show that the polyamide according to the invention has better mechanical properties at room temperature than those obtained with comparative polyamides, which do not meet the total basicity and acidity characteristics. From these results, it can be concluded that the filaments obtained from the polyamide according to the invention have better stretchability and tenacity.

### Example 5: Characterization of the Tenacity of a Polyamide Filament According to the Invention

Filaments are prepared from the polyamide according to the invention PA11 A. The tenacity of the filaments is measured according to standard ISO 2062 at a speed of 250 mm/min and 250 mm distance between the two jaws.

A value of 4.4 cN/dtex is obtained for an elongation of 22%.

Thus, fabrics made with the polyamide according to the invention can be used in the field of sports.

### Example 6: Spinning Process

The PA11 A according to the invention and the comparative PA11 F were evaluated in multi-filament extrusion. The system used was characterized by:
Extruder: 19 mm (¾″) 30:1 L/D
Pump: 0.6 cc/rev
Spinneret pack: 36 holes with L/D=4; L=1.4 mm and D=0.35 mm
Temperature profile in ° C.:

| | | |
|---|---|---|
| Extruder | Z1 | 230 |
| | Z2 | 240 |
| | Z2 | 250 |

| | |
|---|---|
| Pump | 260 |
| Conduit | 260 |
| Jacket | 260 |

The PA11 A according to the invention makes it possible to obtain multi-filaments without difficulties thanks to its fluidity and its rheological stability. The process is stable, with no filament breakage and excellent yield.

However, with the comparative PA11 F, the process is unstable. We observe the formation of a more viscous material at the exit of the spinneret, causing the multi-filaments to break. Indeed, due to its reactivity in the melting stage, the comparative PA11 F's viscosity changes during the spinning process and thus requires a continuous adjustment of the extrusion parameters in order to overcome this problem. However, this is not viable from an industrial point of view.

The comparative PA11 F is therefore not suitable for the manufacture of multi-filaments, whereas the formulation of PA11 A according to the invention is particularly suitable for this type of transformation process.

1. A linear aliphatic polyamide obtained by polycondensation of at least one linear aliphatic unit chosen from a C6 to C12 alpha, omega-aminocarboxylic acid, a C6 to C12 lactam and a (Ca-diamine).(Cb-diacid) unit, with a representing the number of carbon atoms of the diamine and b representing the number of carbon of the diacid, a and b being between 4 and 18,
the polyamide having
a difference, expressed as an absolute value, between its total acidity and its total basicity of between 35 and 180, and
a total basicity or a total acidity strictly less than 35 μeq/g.

2. The polyamide according to claim 1, wherein it has an inherent viscosity of between 0.70 and 1.70.

3. The polyamide according to claim 1, wherein it is a homopolyamide.

4. The polyamide according to claim 3, wherein it is obtained by polycondensation of a linear aliphatic unit chosen from a C8 to C12 alpha, omega-aminocarboxylic acid, a C8 to C12 lactam and a (Ca-diamine).(Cb-diacid) unit, with a representing the number of carbon atoms of the diamine and b representing the number of carbon of the diacid, a and b being between 8 and 12.

5. The polyamide according to claim 4, wherein it is a PA11, PA12, PA1010, PA1012.

6. The polyamide according to claim 1, wherein when the total basicity is strictly less than 35 μeq/g, then the total acidity is between 70 and 180 μeq/g.

7. The polyamide according to claim 1, wherein it is limited by a linear aliphatic C2-C18 monocarboxylic acid, a linear aliphatic C4-C18 monoamine, a linear aliphatic C3-C36 dicarboxylic acid, and/or a linear aliphatic C4-C18 diamine.

8. A method for preparing the polyamide as defined in claim 1, wherein it comprises:
a step of mixing the monomers in the melt stage, and at least one chain terminator, water,
optionally a step of filtering the mixture obtained in the previous step.

9. A composition comprising predominantly the polyamide as defined in claim 1 and at least one additive selected from flame retardants, UV protectants, UV stabilizers, optical brighteners, thermal stabilizers, pigments, lubricants, antioxidants, flow improvers, flowability improvers, film-forming agents, fillers, filming aids, gums, semi-crystalline polymers, preservatives, anti-bacterial agents and mixtures thereof.

10. A method of using the polyamide as defined in claim 1, for the manufacture of textile material.

11. A filament consisting of polyamide as defined in claim .

12. A textile comprising the polyamide as defined in claim 1
